(19) United States
(12) Patent Application Publication
(10) Pub. No.: US 2009/0156067 A1
(43) Pub. Date: Jun. 18, 2009

(54) Electronic Communication System

(76) Inventors: Dickory Rudduck, Chicago, IL (US); Geoffrey Duval Sizer, New South Wales (AU); Adam McArthur, New South Wales (AU); John Wilson, Queensland (AU); Scott Semenik, St. Charles, IL (US); Otokar Kudrna, Burr Ridge, IL (US)

Correspondence Address: TELEZYGOLOGY, INC., 520 W. ERIE STREET, SUITE 210, CHICAGO, IL, 60654, US

(21) Appl. No.: 12/089,703

(22) PCT Filed: Oct. 4, 2006
(86) PCT No.: PCT/AU06/01436

§ 371 Date: Jan. 7, 2009

Related U.S. Application Data
(60) Provisional application No. 60/723,817, filed on Oct. 4, 2005.

(51) Int. Cl. H01R 13/02; H01R 43/20

(52) U.S. Cl. 439/888; 29/747

(57) ABSTRACT

An electronic communication system including: (a) a fastener 2 operable to close or open to secure an item such as a seat 20 to a vehicle; (b) electronic communication means 4 linking the fastener 2 to at least one separate device, such as a second fastener 2 or a handheld remote user-controlled device, to communicate information to the separate device; and (c) electronic circuitry to detect the status of the fastener and to generate the information to be communicated by the electronic communication means to the separate device, wherein the information, which may be an electrical signal such as an electrical pulse, relates to the open or closed status of the fastener.

### FIELD OF THE INVENTION

This invention relates to an electronic method of communication between fasteners and between the user of such a device. The invention also relates to an electronic communication system linking a fastener to another device and/or a user.

### BACKGROUND OF THE INVENTION

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Many devices comprise of fastening systems that must work together in order to perform desired functions. For example, fasteners can work together to guide the installation or removal of a passenger seat system or to hold together parts of machinery or to even hold a door closed. Fasteners are an integral part of the modern world. Many times, a device would work better if one fastener released or locked before another fastener released or locked in a series of events. However, this is not always possible to achieve using existing technology since human error or broken fasteners can affect or even hinder the desired function of a device.

At least in some embodiments, the present invention deals with an electronic means for communication between fasteners. Further comments regarding examples of such solutions are set out below.

### SUMMARY OF THE INVENTION

Broadly, in one aspect this invention relates to an electronic method for communication comprising:
at least one fastener;
wiring; and
electronic circuitry.

In another aspect, this invention relates to an electronic communication system including:
(a) a fastener operable to close or open;
(b) electronic communication means linking said fastener to at least one separate device to communicate information to the separate device; and
(c) electronic circuitry to detect the status of said fastener and to generate the information to be communicated by the electronic communication means to the separate device,
wherein the information relates to the open or closed status of said fastener.

The electronic communication link means may include any suitable means for enabling electronic signals to be sent between, electronic devices or from one device to another. For example, such link means may include electrical wiring, or electromagnetic means such as radio or infrared communication means. Preferably, however, the link means includes wiring physically linking the fastener to the separate device and, optionally, providing a means to deliver power to the fastener.

Preferably, this invention will emphasize the method of integrating a method for a fastener to communicate with a user or with other fasteners in a series. This invention provides a way for intelligent fasteners, such as those activated remotely, to communicate in a way that has not been possible before. Simply put, one fasteners action or inactions affects whether a user or another fastener receives an electronic signal indicating a desired function. Each fastener will preferably comprise of a fastener body and fastener base. It is appreciated that hat fasteners can be used in a variety of forms, such as stud fasteners, a strip fastener, or any other embodiment.

In a preferred setting, the fasteners will comprise of a material adapted to contract when activated. The material adapted to contract when activated is preferably shape, memory alloy strip. Shape memory alloys are known and are usually made predominantly or wholly of titanium and nickel. They may also include other material, such as aluminium, zinc copper, and other similar materials. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the present invention, the shape memory alloy preferably contracts when heated in situ. Shape memory alloy strip currently available, such as that sold under the trade mark Nitinol, is capable of contracting for many cycles by about 3% when activated by heating.

Activation of the material adapted to contract when activated is preferably achieved through electrical resistance heating, with a wire feed to the assembly. Activation of the shape memory alloy strip can be initiated from a central location, using the wiring system of, for example, an aircraft or automobile. It is also within the scope of this invention that the activation is initiated by remote means, such as a hand held tool operating through the use of any suitable form of energy, including microwave, electric magnetic, sonic, infra-red, radio frequency and so on.

The scope of the invention is not necessarily limited to the use of shape memory alloy. Other material may also be useful, such as shape memory polymers and ferromagnetic shape-memory materials. Also, while activation may take place through heating, other means of activation may be suitable and are within the scope of this invention.

In this invention, the fasteners will preferably be activated in a remote manner, meaning that a user does not need to use a physical action to manipulate a fastener. This may happen by way of key fob or by way of an electric network within the device. However, it is anticipated that a fastener in this invention can experience physical manipulation to activate other fasteners in the series or to activate the method of indicating to a user that an event has occurred.

Each fastener base comprises an electronic circuitry. Such circuitry is necessary for remote activation. In the locked position, the fastener body makes a physical connection with the fastener base activating the electronic circuitry. In the unlocked position, the fastener body is separated from the fastener base.

In this invention, fasteners communicating with one another is integral for the function of the device. The method in which they do communicate is through wiring. The electronic method of communication, i.e. through the wiring, between fasteners can run outside the body of the fastener as a modular attachment to the fastener. The electronic method can also be easily anticipated as integrated within the fastener. The choice of electronic means depends on the device at issue. It is equally applicable for the fasteners to communicate with the user. To lock the fasteners of a device, the fastener body of one fastener is joined with the fastener base of that same fastener. The physical connection between the fastener base and the fastener body triggers a switch within the fastener signaling to an electronic means to communicate with another fastener. This communication notifies the second fastener to act in the manner desired. This same function can notify a user that a function has been performed.

It can also be anticipated that these fasteners can default to a locked position if such a feature is desired to protect the integrity of the device. In cases of electrical failure or some other unforeseen electrical problem, it is important to recognize that the fasteners can be designed to protect the overall integrity, design, and function of the device.

In an automobile setting, a fastener can be connected and indicate that a radio is functioning properly to an end user or could possibly pin point the source of any error. A series of fasteners can work together to release a removable seat in that same automobile or to indicate that a passenger seat is installed properly. While examples of the automotive nature are given, one skilled in the art will readily recognize applications in other industries.

### DETAILED DESCRIPTION OF THE DRAWINGS

Possible and preferred features of the present invention will now be described with particular reference to the accompanying drawings. However, it is to be understood that the features illustrated in and described with reference to the drawings are not to be construed as limiting on the broad scope of the invention. In the drawings:

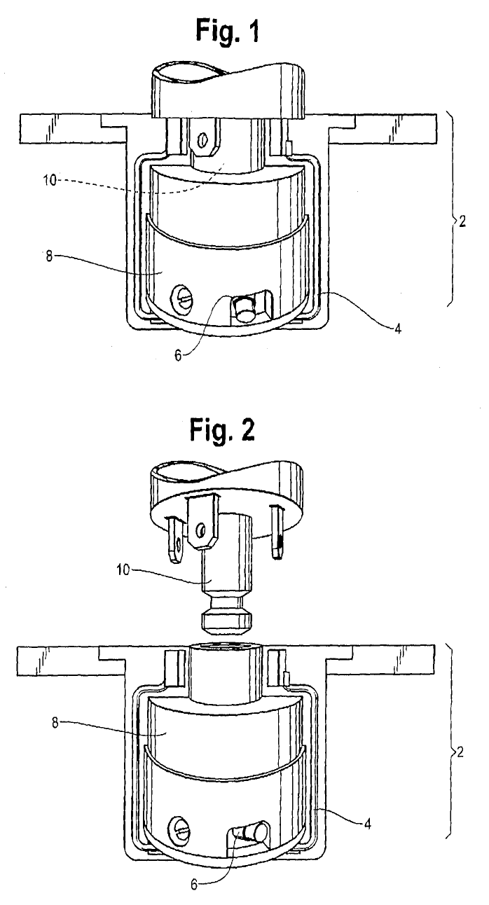

FIG. 1 is a detailed view of a fastener in the locked position.

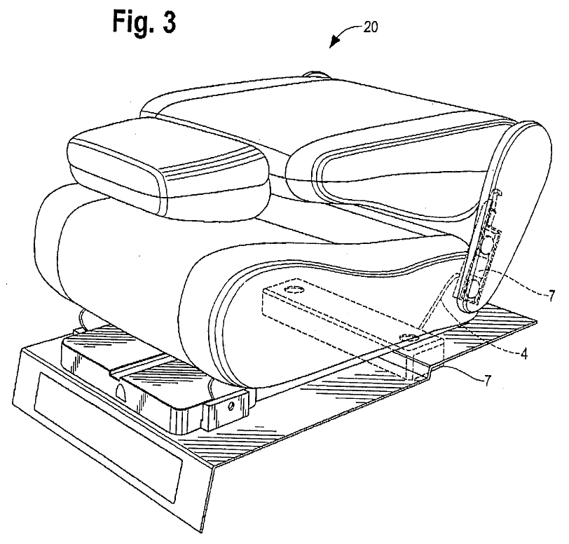

FIG. 2 is a detailed view of a fastener in the unlocked position.

FIG. 3 is a view of the electronic means communicating between two fasteners within a passenger seat for a vehicle.

### DETAILED DESCRIPTION OF THE PREFERRED EMBODIMENT

In a preferred embodiment, the electronic method for communication comprises at least one fastener 2, wiring 4, and electronic circuitry 6. The at least one fastener 2 comprises of a fastener base 8 and fastener body 10. The at least one fastener 2 can comprise of a series of fasteners communicating with each other or with a user. It is equally important to note that simply one fastener 2 can communicate with a user as well.

In this invention, the fastener 2 can communicate with another fastener 2 or with a user though wiring 4. The wiring can be a modular attachment to the fastener 2 running along the outside of the fastener 2 or the wiring can be fully integrated within the fastener.

In the series of fasteners, a fastener base 8 makes a physical connection with the fastener body 10. This connection flips a type of switch with the electronic circuitry 6. The electronic circuitry 6 sends a signal to the wiring 4 to tell another fastener 2 in the series to perform in a desired manner. It is just as readily anticipated that the wiring 4 can send a communication to the user of the device that the fastener 2 are performing a specific, desired function. The user can also be relayed a message that a series of fasteners is functioning in a proper manner as well, or also be alerted to the occurrence of a failure. One skilled in the art will recognize that the fastener body 10 and fastener base 8 can release connection from each other sending similar instructions to other fasteners or the user as it would when making a connection.

This method of communication utilizing wiring 4 can be an integral part of any device. Almost any device can benefit from an embodiment of a fastener 2 communicating with a user to indicate a function or malfunction. On that same note, a preferred embodiment of any device would benefit from its series of fasteners communicating with each other for optimal function. This method allows devices to achieve optimal function by relaying signals of performance.

FIG. 3 depicts this invention in a passenger seat setting. The fastener 2, and electronic circuitry 6 are at least partially contained in the box 7 In FIG. 3, the wiring 4 connects the two fasteners in series. When one of the fasteners 2 is locked or unlocked as seen in FIGS. 1 and 2, that action is relayed to the other fastener in the series or to a user (not seen). In the case of the passenger seat 20, this method can be used to detect whether or not a seat is installed properly or is functioning properly.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the fastener body 8 uppermost.

It will be appreciated by those skilled in the art that many modifications and variations may be made to the embodiments described herein without departing from the spirit and scope of the invention.

1. An electronic method for communication of a signal between a fastener and another fastener or a user, said fastener including:
a fastener body having a catch portion; and
a fastener base having a complementary receiving means for engageably receiving said catch portion,
said fastener body including circuit completion means to electrically connect with terminal means in said fastener base to complete an electronic circuit; and
said fastener base including wiring to electrically communicate the connection of said circuit completion means with said terminal means to the other fastener or said user.

2. The electronic method according to claim 1, wherein said fastener base further includes a manual override switch that toggles between activation and deactivation positions of the fastener.

3. The electronic method of claim 1, wherein said fastener is one of a series of two or more fasteners.

4. The electronic method of claim 1, wherein said wiring can communicate fastener function to the user.

5. A method for electronic communication of a signal between a first fastener and another fastener in a series of two or more fasteners, said first fastener including:
a fastener body having a catch portion, said fastener body including circuit completion means to electrically connect with terminal means to complete an electronic circuit; and
a fastener base including said terminal means, a complementary receiving means for engageably receiving said catch portion and wiring to electrically communicate the connection of said circuit completion means with said terminal means to the other fastener,
said method including the steps of:
said fastener body making connection with said fastener base thereby locking said first fastener;
said connection switching said electronic circuit; and
said electronic circuit signalling to the other fastener to activate or deactivate.

6. A method for electronic communication of a signal between a first fastener and another fastener in a series of two or more fasteners, said first fastener including:
a fastener body having a catch portion, said fastener body including circuit completion means to electrically connect with terminal means to complete an electronic circuit; and
a fastener base including said terminal means, a complementary receiving means for engageably receiving said catch portion and wiring to electrically communicate the connection of said circuit completion means with said terminal means to the other fastener,
said method including the steps of:
said fastener body releasing connection from said fastener base to assume its unlocked state;
said connection release switching said electronic circuit; and
said electronic circuit signalling to the other fastener to activate or deactivate.

7. An electronic communication system for communication of information from a fastener to at least one separate device, said system including:
(a) the fastener operable to close or open and including:
(i) a fastener body having a catch portion; and
(iii) a fastener base having a complementary receiving means for engageably receiving said catch portion;
(b) electronic circuitry at least partially included in said fastener base to detect the closed or open status of said fastener and to generate the information relating to the open or closed status of said fastener; and
(c) electronic communication means linking said fastener to the at least one separate device to communicate the information,
wherein:
said fastener body includes circuit completion means to electrically connect with terminal means in said fastener base to complete said electronic circuitry.

8. The system of claim 7, wherein said electronic communication means includes electrical wire means linking said fastener to the separate device.

9. The system of claim 7, wherein said system is hardwired to a substrate having a power source.

10. The system of claim 9, wherein said substrate is a vehicle, including an aircraft or an automobile, and said power source is derived from said vehicle's power source.

11. The system of claim 7, wherein said electronic communication means is external to said fastener and is a modular component of said system.

12. The system of claim 7, wherein said at least one separate device includes one or more fasteners.

13. The system of claim 12, wherein said one or more fasteners are of like type to said fastener.

14. The system of claim 7, wherein said fastener releasably and securely engages a first and a second item together.

15. The system of claim 7, wherein said fastener includes a component made of memory material that includes at least two shape configurations corresponding to the open and closed status of said fastener.

16. The system of claim 7, wherein said at least one separate device is a remote device viewed and/or controlled by a user.

17. The system of claim 7, wherein said electronic communication means includes wireless communication means linking said fastener to the separate device.

18. The system of claim 17, wherein said system includes an independent power source.

19. The system of claim 18, wherein said independent power source includes a battery.
